(19) United States
(12) Patent Application Publication
(10) Pub. No.: US 2010/0212396 A1
(43) Pub. Date: Aug. 26, 2010

(54) DOWNHOLE SENSOR APPARATUS AND METHOD

(76) Inventor: Brett Zenisek, Windsor, CO (US)

Correspondence Address: MCAFEE & TAFT;TENTH FLOOR, TWO LEADERSHIP SQUARE, 211 NORTH ROBINSON, OKLAHOMA CITY, OK, 73102, US

(21) Appl. No.: 12/391,680

(22) Filed: Feb. 24, 2009

(51) Int. Cl. G01L 27/00; E21B 47/06

(52) U.S. Cl. 73/1.57; 73/152.55; 73/152.39

(57) ABSTRACT

The present invention relates to a sensor assembly for downhole use in a wellbore. This invention also relates to a new pack-off assembly housing the sensor. The new pack-off assembly protects the sensor from the environment and from impact damage. Additionally, the new pack-off assembly allows for the testing of the sensor immediately prior to insertion into the wellbore.

### BACKGROUND OF THE INVENTION

The present invention relates to a sensor assembly for downhole use in a wellbore. This invention also relates to a new pack-off assembly housing the sensor.

Downhole sensors are used to measure pressure, flow and/or other conditions in a well. Often, the sensor must be positioned near the point of production and is subjected to extreme temperatures, pressures, vibrations, and other abuses. In addition, because the downhole environment is a high pressure environment, it is highly desired to pressure test the sensor assembly after fabrication and prior to deploying the assembly downhole.

The sensor of the current disclosure provides not only for the capability to conduct pressure testing of the downhole sensor assembly prior to deployment in the downhole environment, but also protects the sensor so as to limit damage during deployment.

### SUMMARY OF THE INVENTION

The downhole sensor assembly is attached to a tubing string that is disposed in a wellbore that may be cased or uncased. In one embodiment, a sensor assembly for use in a wellbore is provided. The sensor assembly is able to be attached to a tubing string that is lowered into the wellbore. The sensor assembly includes a pack-off pipe, a sensor sleeve, and a sensor. The sensor sleeve has a first end and a second end. The first end of the sensor sleeve is adapted to be exposed to the wellbore, and has an internally threaded surface. The internally threaded surface is for receiving a test device. The sensor is for sensing a parameter in the wellbore. The sensor is secured to the second end of the sensor sleeve and is positioned within the pack-off pipe.

In another embodiment, a downhole sensor assembly for use in a wellbore is provided. The downhole sensor includes a pipe, a tubular sleeve and a sensor. The pipe is adapted to be secured to a tubing string and lowered into the wellbore. The pipe has a first end and a second end. The tubular sleeve has a first end and a second end. The tubular sleeve is positioned within the pipe. The tubular sleeve first end is exposed to the wellbore and is capable of receiving a test device. The sensor is for sensing a parameter in the wellbore. The sensor is secured to the second end of the tubular sleeve and is positioned within the pipe. The sensor and pipe form an annulus therebetween.

In yet another embodiment, a downhole sensor assembly for use in a wellbore is provided. The downhole sensor assembly comprises a pack-off pipe, a sensor sleeve, a test chamber and a sensor. The sensor sleeve is positioned in the pack-off pipe. The sensor sleeve has a first set of internal mounting threads positioned near a first end of the sensor sleeve. The sensor sleeve has a second set of internal mounting threads positioned near a second end of the sensor sleeve. The first set of mounting threads in the sensor sleeve is adapted to receive a test device. The test chamber is positioned in the sensor sleeve between the first and second sets of internal mounting threads. The sensor is for sensing a parameter in the wellbore. The sensor is secured to the second set of mounting threads and is positioned in the pack-off pipe.

The objects, features and advantages of the present invention will be readily apparent to those skilled in the art upon a reading of the description of preferred embodiments when taken in conjunction with the accompanying drawings.

### BRIEF DESCRIPTION OF THE DRAWINGS

FIG. 1 depicts a schematic view of a sensor assembly disposed in a wellbore.

FIG. 2 depicts a side section view of a sensor assembly.

FIG. 3 depicts a section view of a sensor sleeve.

FIG. 4 depicts an exploded view of a sensor assembly.

### DETAILED DESCRIPTION

Referring to the drawings, a downhole sensor assembly is illustrated and generally designated by the numeral 10, and the components thereof are designed to be associated with downhole tubing string 12.

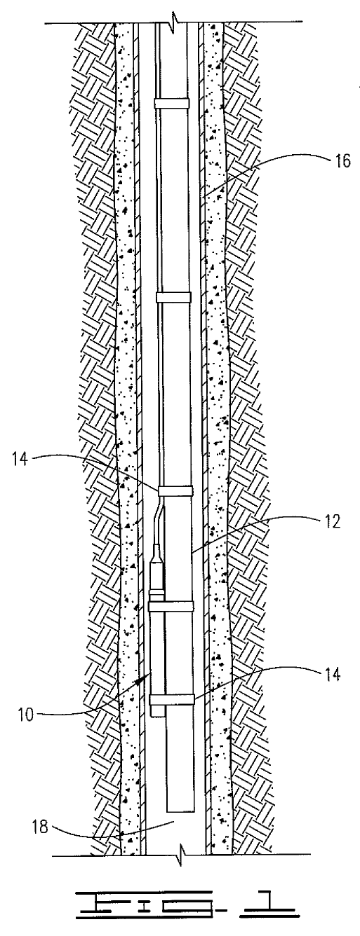

Downhole sensor assembly 10 shown in FIG. 1 is secured to a tubing string 12. Tubing string 12 may be disposed with or without tools attached thereto. Straps 14 are shown securing downhole sensor assembly 10 to tubing string 12. However, other connective devices or other means to externally connect downhole sensor assembly 10 to tubing string 12 may be used in place of straps 14. In FIG. 1, tubing string 12 is disposed inside a casing 16 of wellbore 18. However, tubing string 12 may be disposed in wellbore 18 without casing 16.

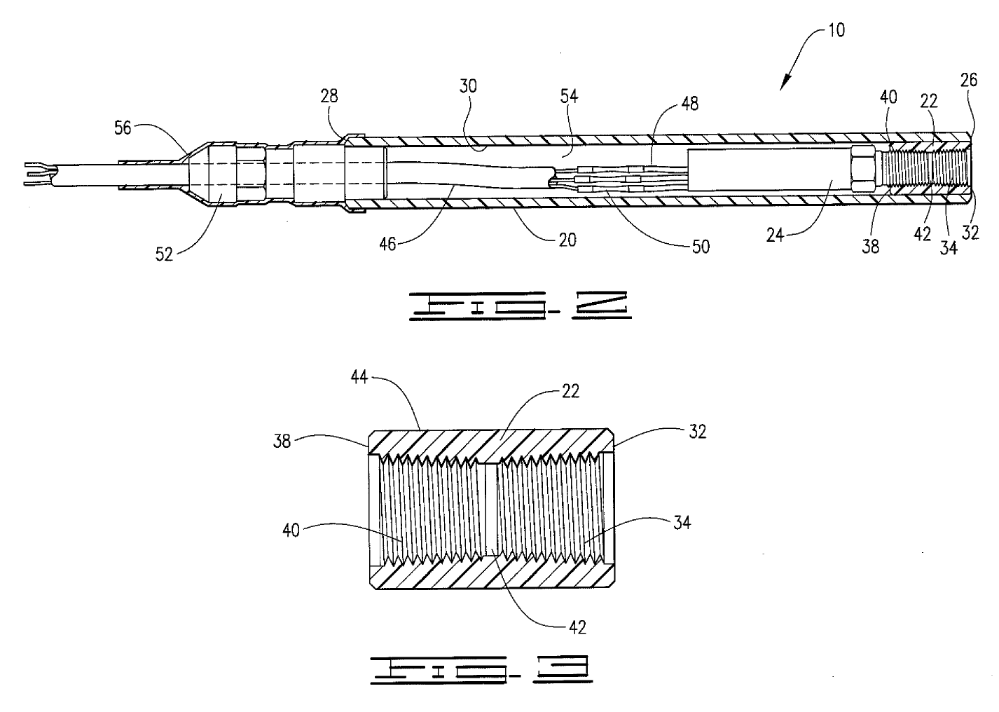

FIGS. 2-4 show downhole sensor assembly 10 in greater detail. Downhole sensor assembly 10 comprises a pack-off pipe 20 having tubular sensor sleeve 22 and sensor 24 positioned therein. Pack-off pipe 20 has pipe first end 26, pipe second end 28, and pipe inner surface 30. Preferably, tubular sensor sleeve 22 is positioned at, or near, pipe first end 26.

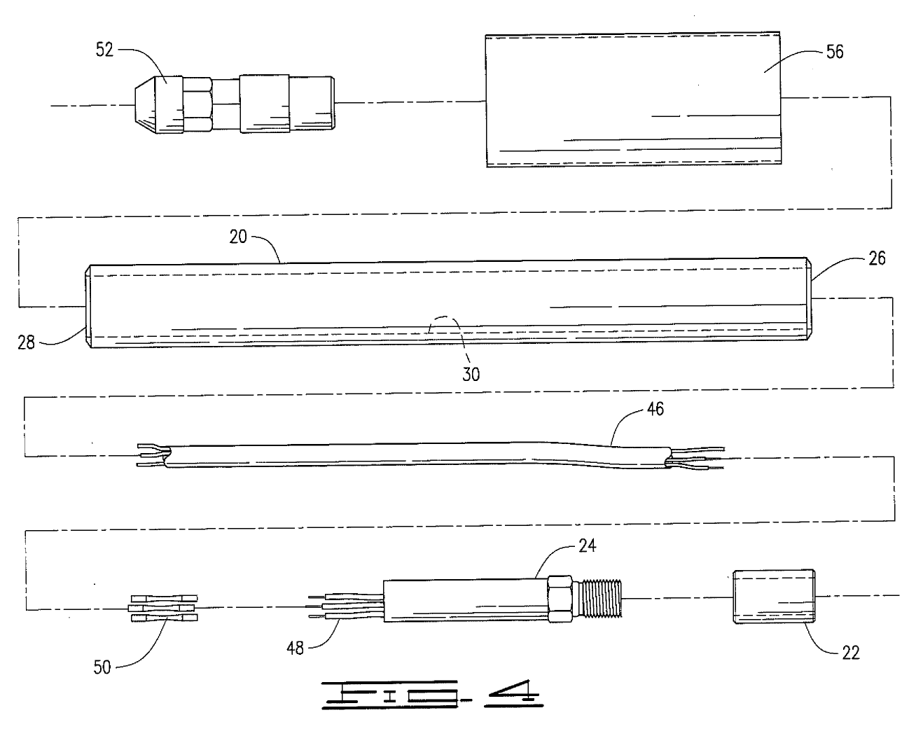

Sensor sleeve 22, depicted in FIGS. 2 and 3, is tubular shaped and has sleeve first end 32, or outer end 32. Sensor sleeve 22 has a first set of internal mounting threads 34 axially positioned thereon, which are preferably, progressively tapered radially inward from the sleeve first end 32.

Tubular sensor sleeve 22 also has sleeve second end 38, or inner end 38, which is adapted to receive and secure sensor 24. As shown in FIGS. 2 and 3, sensor sleeve 22 has a second set of internal mounting threads 40 internally positioned thereon and adjacent to sensor 24. Second set of internal mounting threads 40 are for connecting to sensor 24. Although second set of internal mounting threads 40 are depicted in FIGS. 2 and 3, second sleeve end 38 may employ any connective mechanism that will secure sensor 24 in tubular sensor sleeve 22.

Sensor 24, as shown in FIGS. 2 and 4, is a pressure transducer. However, it is understood that any type of sensor device that is capable of detecting a particular parameter of the downhole environment may be utilized in downhole sensor assembly 10. For example, it is known that the pressure transducer shown in FIGS. 2 and 4 can be replaced with a conductive sensor capable of measuring temperature or chemical composition. With regards to a pressure transducer, sensor 24 is able to detect the pressure in wellbore 18, as sleeve first end 32 is open to the wellbore.

Test chamber 42 is positioned between sleeve first end 32 and sleeve second end 38. Test chamber 42 is sometime referred to as a gap or space. Test chamber 42 may be threaded or unthreaded, as long as there is a chamber or space for testing the performance of sensor 24. Test chamber 42 is a test chamber positioned to test sensor 24 after assembly, and prior to deployment of sensor assembly 10 into wellbore 18.

Sensor 24 has sleeve exterior surface 44 as shown in FIGS. 2 and 3. Sleeve exterior surface 44 is adapted to sealingly engage pipe inner surface 30 when assembled. The means of sealingly engaging sleeve exterior surface 44 with pipe inner surface 30 is common in the downhole test equipment assembly process, and thus not discussed herein. When assembled, sleeve first end 32 and pipe first end 26 are preferably planarly flush with each other.

First set of internal mounting threads 34 are adapted to receive a compatible piece of test equipment (not shown). In the preferred embodiment, for the example pressure transducer, the test equipment is adapted to provide pressure testing of sensor 24 after complete assembly of sensor assembly 10, and again, prior to insertion into wellbore 18. The pressure test equipment may be threaded into first set of internal mounting threads 34 and then a pressure applied within test chamber 42. Sensor 24 may therefore be tested after sensor assembly 10 is fully assembled, and prior to deployment in wellbore 18. Any pressure test equipment threaded into first set of internal mounting threads 34 will be removed prior to deployment so that sensor 24 will sense pressure in wellbore 18 through the open sleeve first end 32 of sensor sleeve 22. For other types of sensors, the appropriate type of test equipment may also be attached and utilized to test that other type of sensor after assembly and prior to insertion. A non-limiting example of another type of sensor test equipment might be a temperature sensor test equipment device.

As shown, in FIGS. 2 and 4, downhole sensor assembly 10 also includes sensor cable 46 connected to connecting cables 48 of sensor 24 with connectors 50. Sensor cable 46 is positioned through the center of pack-off end 52.

When sensor 24 is secured, sensor 24 and pack-off pipe 20 form annulus 54, which is a cavity between sensor 24 and pipe inner surface 30. FIG. 2 shows sensor 24 positioned within pack-off pipe 20 and surrounded by annulus 54. Annulus 54 is preferably substantially filled with a fluid compound capable of providing increased stability of downhole sensor assembly 10, and to further secure sensor 24 within pack-off pipe 20. The fluid compound is preferably a thermosetting polymer, but it may be any pourable or injectable compound capable of securing sensor 24 in pack-off pipe 20 with a water tight seal. Preferably, the thermosetting polymer securing sensor 24 does not interfere with the function of sensor 24. During the assembly process, pack-off end 52 may be secured to pipe second end 28 of pack-off pipe 20 by threads, glue, welding or other means known to those skilled in the art. Once pack-off end 52 is secured, it is preferred to apply shrink wrap 56 over pack-off end 52 and pipe second end 28 to further seal downhole sensor assembly 10.

Downhole sensor assembly 10 provides advantages over other sensor assemblies in that it is protected from the environment and from impact damage. In addition, sensor 24 can be tested not only prior to the insertion into pack-off pipe 20, but also immediately prior to insertion into wellbore 18. Testing is accomplished by connecting the pressure test equipment to sensor sleeve 22 as described herein. Once in a wellbore, parameters, e.g. pressure, are sent via a signal to the surface through sensor cable 46.

The current invention also provides methods for assembling and testing sensor 24 of downhole sensor assembly 10. The method for assembling downhole sensor assembly 10 provides a sensor sleeve 22 that is positioned within pack-off pipe 20 at, or near, pipe first end 26. Sensor sleeve 22 is secured, or affixed, internally to pack-off pipe 20, with first end 32 of sensor sleeve 22 being open towards pipe first end 26 of downhole sensor assembly 10. A glue-like substance or weld is preferably utilized to secure sensor sleeve 22 in pack-off pipe 20. However, other means of securing sensor sleeve 22 may be utilized, as long as the securing of sensor sleeve 22 provides a water-tight seal within pack-off pipe 20. Sensor 24 is preferably further sealed into pack-off pipe 20 by substantially filling annulus 54 with a fluid compound, such as a thermosetting polymer. Sensor 24 is secured in sleeve second end 38 of sensor sleeve 22 as described herein. Pipe second end 28 of pack-off pipe 20 is sealed by applying shrink wrap 56 to pack-off end 52 and pipe second end 28.

The method of pressure testing sensor 24 for calibration prior to deployment in wellbore 18 includes attaching a piece of test equipment to sleeve first end 32 of sensor assembly 10. The test equipment is threadedly secured in sleeve first end 32 of said sensor assembly 10 and forms test chamber 42 between the test equipment and sensor 24. A known pressure is applied to test chamber 42 with the test equipment. A measurement of the pressure sensed by sensor 24 is taken.

The pressure measured by sensor 24 is compared to the known pressure from the test equipment. If the measured pressure is substantially similar to the known pressure, sensor 24 is acceptable. If the measured pressure is not substantially similar to the known pressure, sensor 24 has failed the test. The sensor 24 that failed may be retested, or another sensor assembly 10 may be used to replace the failed sensor 24. Once the testing is completed, the calibrated pressure of sensor 24 is known and the test equipment is removed from sleeve first end 32. If sensor 24 is acceptable, sensor assembly 10 is ready for deployment in wellbore 18.

The assembled sensor assembly 10 is attached tubing string 12 as described herein. Sensor assembly 10 is inserted to wellbore 18, along with tubing string 12, to provide detection of a parameter within wellbore 18.

Other embodiments of the current invention will be apparent to those skilled in the art from a consideration of this specification, or practice of the invention disclosed herein. Thus, the foregoing specification is considered merely exemplary of the current invention with the true scope thereof being defined by the following claims.

What is claimed is:

1. A sensor assembly for use in a wellbore comprising:
a pack-off pipe;
a sensor sleeve having a first end and a second end, said first end adapted to be exposed to said wellbore, wherein said first end has an internally threaded surface for receiving a test device; and
a sensor for sensing a parameter in said wellbore and secured to said second end of said sensor sleeve, wherein said sensor is positioned within said pack-off pipe.

2. The sensor assembly of claim 1, wherein said internally threaded surface is increasingly radially tapered axially from said first end of said sensor sleeve.

3. The sensor assembly of claim 1, further comprising a chamber internally positioned between the first and second ends of said sensor sleeve.

4. The sensor assembly of claim 1, wherein said first end of said sensor sleeve is flush with an end of said pack-off pipe.

5. The sensor assembly of claim 1, wherein said sensor positioned within said pack-off pipe forms an annulus, said annulus being substantially filled with a fluid compound.

6. The sensor assembly of claim 5, wherein said fluid compound is a thermosetting polymer.

7. A downhole sensor assembly for use in a wellbore comprising:
a pipe adapted to be secured to a tubing string and lowered into the wellbore, said pipe having a first end and a second end;
a tubular sleeve having a first end and a second end positioned within said pipe, wherein said first end of said tubular sleeve is exposed to said wellbore and capable of receiving a test device; and
a sensor for sensing a parameter in the wellbore, said sensor being secured to said second end of said tubular sleeve and positioned within said pipe, said sensor and said pipe forming an annulus therebetween.

8. The sensor assembly of claim 7, wherein said first end of said tubular sleeve has an internal thread.

9. The sensor assembly of claim 7, further comprising a parameter test chamber positioned between said first and second ends of said tubular sleeve.

10. The sensor assembly of claim 7, wherein said first end of said tubular sleeve is flush with said first end of said pipe.

11. The sensor assembly of claim 7, wherein said annulus is substantially filled with a fluid compound.

12. The sensor assembly of claim 11, wherein said fluid compound is a thermosetting polymer.

13. The sensor assembly of claim 7, wherein said tubular sleeve sealingly engages said pipe along an inner surface of said pipe.

14. The sensor assembly of claim 7, further comprising a signal cable attached to said sensor.

15. A downhole sensor assembly for use in a wellbore comprising:
a pack-off pipe;
a sensor sleeve positioned in said pack-off pipe, said sensor sleeve having a first set of internal mounting threads positioned at a first end of said sensor sleeve, and said sensor sleeve having a second set of internal mounting threads positioned at a second end of said sensor sleeve, wherein said first set of mounting threads is adapted to receive a test device;
a test chamber positioned in said sensor sleeve between said first and second mounting threads; and
a sensor for sensing a parameter in the wellbore, said sensor being secured to said second set of mounting threads and positioned within said pack-off pipe.

16. The downhole sensor assembly of claim 15, wherein said first set of mounting threads increasingly taper radially inwardly from said first end of said sensor sleeve towards said test chamber.

17. The downhole sensor assembly of claim 15, wherein said first end of said sensor sleeve and an end of said pack-off pipe are flush.

18. The downhole sensor assembly of claim 15, wherein said sensor and said pack-off pipe form an annulus, said annulus being substantially filled with a fluid compound.

19. The downhole sensor assembly of claim 18, wherein said fluid compound is a thermosetting polymer.

20. A method for calibration pressure testing a sensor prior to deployment in a wellbore comprising the steps of:
forming a test chamber within a sensor assembly by attaching a piece of test equipment to a first end of said sensor assembly, wherein said test equipment is threadedly secured in a first end of said sensor assembly thereby forming a test chamber between said test equipment and said sensor;
applying a known pressure to said test chamber with said test equipment;
measuring said pressure with said sensor; and
removing said test equipment.

21. The method of claim 20, further comprising comparing said measurement with said known pressure.

22. The method of claim 21, wherein if said measurement is substantially similar to said known pressure, said sensor is acceptable.

23. The method of claim 22, further comprising deploying said sensor assembly in said wellbore.

24. A method for testing of a sensor assembly comprising the steps of:
inserting a sensor sleeve into a pack-off pipe;
securing said sensor sleeve having a first end within said pack-off pipe, wherein said first end of said sensor sleeve is positioned near a first end of said pack-off pipe, said first end of said sensor sleeve being open;
securing a sensor to a second end of said sensor sleeve, said second end being internally positioned within said pack-off pipe;
sealing a second end of said pack-off pipe;
forming a test chamber within said pack-off pipe by threadedly attaching a piece of test equipment to said first end of said pack-off pipe, thereby forming said test chamber, said test chamber being positioned between said sensor and said piece of test equipment;
applying a known pressure to said test chamber with said piece of test equipment;
measuring said pressure with said sensor;
removing said test equipment;
attaching said pack-off pipe with said sensor to a tubing string; and
inserting said tubing string into a wellbore.

25. The method of claim 24, farther comprising the step of comparing said measurement with said known pressure, wherein if said measurement is substantially similar to said known pressure, said sensor is acceptable.

26. The method of claim 24, further comprising the step of injecting a fluid compound into an annulus formed between said sensor and said pack-off pipe.

27. The method of claim 24, further comprising the step of applying a glue-like substance to secure said sensor sleeve within said pack-off pipe.

28. The method of claim 24, further comprising the step of welding said sensor sleeve within said pack-off pipe to secure said sensor sleeve therein.
